(19) United States
(12) Patent Application Publication
(10) Pub. No.: US 2024/0354682 A1
(43) Pub. Date: Oct. 24, 2024

(54) DATA ENTHALPY BASED INTELLIGENT DATA INSIGHT GENERATION SYSTEM

(71) Applicant: Accenture Global Solutions Limited, Dublin (IE)

(72) Inventors: Rajeev John, Pune (IN); Saurabh PATHAK, Pune (IN)

(73) Assignee: Accenture Global Solutions Limited, Dublin (IE)

(21) Appl. No.: 18/135,920

(22) Filed: Apr. 18, 2023

(51) Int. Cl. G06Q 10/10

(52) U.S. Cl. CPC G06Q 10/06393

(57) ABSTRACT

A method and system for generating recommended data insights are disclosed. The method may include obtaining available Key Performance Indicators (KPIs) associated with an operation process from a KPI repository. The available KPIs may represent metrics that can be calculated based on data for the operation process stored in a data repository. The method may include identifying in-use KPIs comprising a subset of the available KPIs and calculating a data enthalpy metric for the operation process based on a number of the available KPIs and a number of the in-use KPIs. The method may further include obtaining an insight recommendation model trained to predict a significance of an available KPI not in use, executing the insight recommendation model to generate a KPI recommendation for the operation process based on the data enthalpy metric, and outputting the KPI recommendation via the user interface.

### TECHNICAL FIELD

This disclosure relates to data processing, in particular, to generating data insights based on data enthalpy.

### BACKGROUND

Organizations are creating or have created data lakes, data warehouses, or system of insights (SOIs) to serve analytical and reporting needs. Data in the data lake may be retrieved from various system of records. The data may be further categorized in the form of data assets. The data asset may be defined as overarching domain to which data can be categorized, for example, finance, legal, human resources, customer acquisition and retention, sales, operations, and the like. It is often that the organizations build several dashboards and key performance indicators (KPIs) only based on limited data. Most of the data in the data lake remains unutilized and the potential of the data is not sufficiently explored.

### SUMMARY

This disclosure relates to systems and methods for increasing data enthalpy realization to generate additional data insights.

In one embodiment, a method for increasing data enthalpy realization is disclosed. The method may include obtaining available KPIs associated with an operation process from a KPI repository. The available KPIs may represent metrics that can be calculated based on data for the operation process stored in a data repository. The method may further include identifying in-use KPIs including a subset of the available KPIs. The in-use KPIs may be outputted as data insights via a user interface. The method may further include calculating a data enthalpy metric for the operation process based on a number of the available KPIs and a number of the in-use KPIs. The data enthalpy metric may indicate a relative amount of unutilized data for calculating a KPI. The method may further include obtaining an insight recommendation model trained to predict a significance of an available KPI not in use, executing the insight recommendation model to generate a KPI recommendation for the operation process based on the data enthalpy metric, and outputting the KPI recommendation via the user interface.

In another embodiment, a system for increasing data enthalpy realization is disclosed. The system may include a memory having stored thereon executable instructions and a processor circuitry in communication with the memory. When executing the instructions, the processor circuitry may be configured to obtain available KPIs associated with an operation process from a KPI repository. The available KPIs may represent metrics that can be calculated based on data for the operation process stored in a data repository. The processor circuitry may be further configured to identify in-use KPIs including a subset of the available KPIs. The in-use KPIs may be outputted as data insights via a user interface. The processor circuitry may be further configured to calculate a data enthalpy metric for the operation process based on a number of the available KPIs and a number of the in-use KPIs. The data enthalpy metric may indicate a relative amount of unutilized data for calculating a KPI. The processor circuitry may be further configured to obtain an insight recommendation model trained to predict a significance of an available KPI not in use, execute the insight recommendation model to generate a KPI recommendation for the operation process based on the data enthalpy metric, and output the KPI recommendation via the user interface.

In another embodiment, a product for increasing data enthalpy realization is disclosed. The product may include non-transitory machine-readable media and instructions stored on the machine-readable media. When being executed, the instructions may be configured to cause a processor circuitry to obtain available KPIs associated with an operation process from a KPI repository. The available KPIs may represent metrics that can be calculated based on data for the operation process stored in a data repository. The instructions may be further configured to cause the processor circuitry to identify in-use KPIs including a subset of the available KPIs. The in-use KPIs may be outputted as data insights via a user interface. The instructions may be further configured to cause the processor circuitry to calculate a data enthalpy metric for the operation process based on a number of the available KPIs and a number of the in-use KPIs. The data enthalpy metric may indicate a relative amount of unutilized data for calculating a KPI. The instructions may be further configured to cause the processor circuitry to obtain an insight recommendation model trained to predict a significance of an available KPI not in use, execute the insight recommendation model to generate a KPI recommendation for the operation process based on the data enthalpy metric, and output the KPI recommendation via the user interface.

The above embodiments and other aspects and alternatives of their implementations are explained in greater detail in the drawings, the descriptions, and the claims.

### BRIEF DESCRIPTION OF THE DRAWINGS

The present disclosure may be better understood with reference to the following drawings and description. The components in the figures are not necessarily to scale. Moreover, in the figures, like-referenced numerals designate corresponding parts throughout the different views.

FIG. 1 shows an exemplary architecture for increasing data enthalpy realization.

FIG. 2 shows an exemplary data insight generation logic for increasing data enthalpy realization.

FIG. 3 shows an exemplary architecture for training the insight recommendation model.

FIG. 4 shows an exemplary specific execution environment for executing the data insight generation logic for increasing data enthalpy realization.

### DETAILED DESCRIPTION

The disclosure will now be described in detail hereinafter with reference to the accompanied drawings, which form a part of the present disclosure, and which show, by way of illustration, specific examples of embodiments. Please note that the disclosure may, however, be embodied in a variety of different forms and, therefore, the covered or claimed subject matter is intended to be construed as not being limited to any of the embodiments to be set forth below. Please also note that the disclosure may be embodied as methods, devices, components, or systems. Accordingly, embodiments of the disclosure may, for example, take the form of hardware, software, firmware or any combination thereof.

Throughout the specification and claims, terms may have nuanced meanings suggested or implied in context beyond an explicitly stated meaning. Likewise, the phrase “in an embodiment” or “in an implementation” as used herein does not necessarily refer to the same embodiment or implementation and the phrase “in another embodiment” or “in another implementation” as used herein does not necessarily refer to a different embodiment or implementation. It is intended, for example, that claimed subject matter includes combinations of exemplary embodiments or implementations in whole or in part.

Dictionary definition of the term enthalpy is the sum the internal energy of a body and the product its volume multiplied by the pressure. In the present disclosure, the data enthalpy may represent untapped potential of the data in data repositories that could be translated into meaningful data insights, for example, in the form of key performance indicators (KPIs) for further consumption into reports or dashboards. The data repository may represent a data storage entity into which data has been partitioned for an analytical or reporting purpose. The data repository may include, for example, data lake, data warehouse, and system of insight (SOI). The systems and methods in the present disclosure may facilitate to increase data enthalpy realization by intelligently improving the utilization of the data for generating additional data insights.

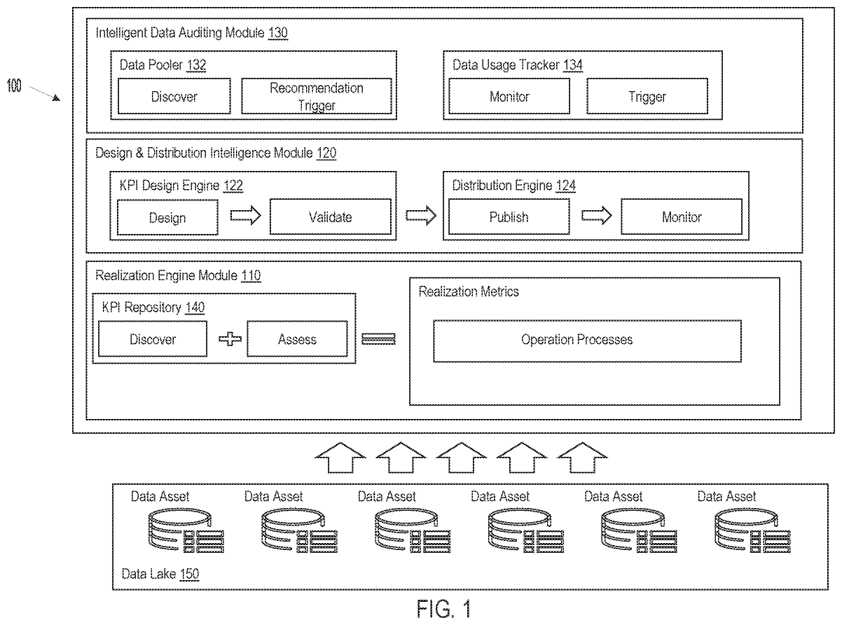

FIG. 1 shows exemplary architecture 100 for increasing data enthalpy realization. The architecture 100 may include realization engine module 110, design and distribution intelligence module 120, and intelligent data auditing module 130. The design and distribution intelligence module 120 may include KPI design engine 122 and distribution engine 124. The intelligent data auditing module 130 may include data pooler 132 and data usage tracker 134. The modules may operate collaboratively to increase the data enthalpy realization as discussed in the present disclosure.

Herein, the term module may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the unit. A module is configured to perform functions and achieve goals such as those described in this disclosure, and may work together with other related modules, programs, and components to achieve those functions and goals.

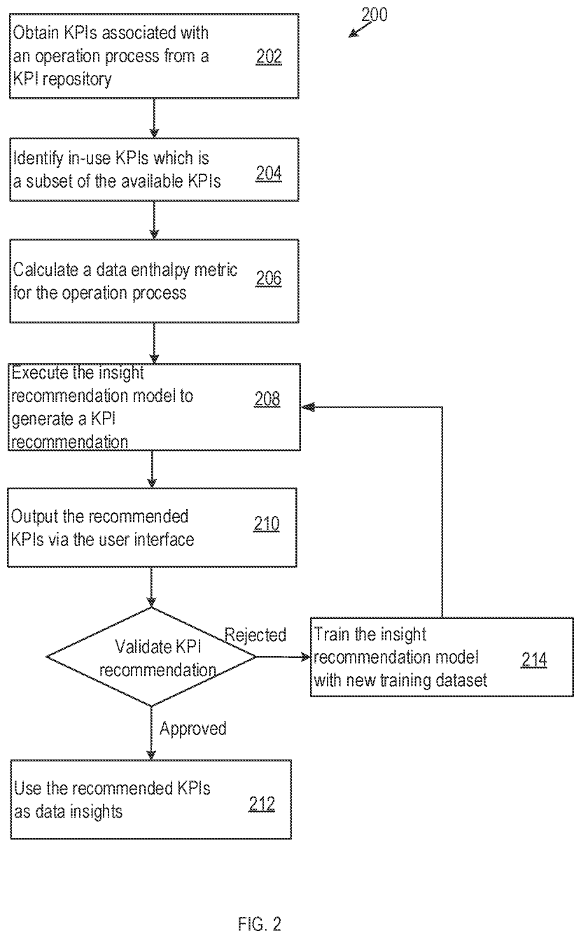

FIG. 2 shows an exemplary data insight generation logic (DIGL) 200 for increasing the data enthalpy realization. The logical features in the DIGL 200 will be discussed with reference to FIG. 1 and FIG. 2.

At the realization engine module 110, the DIGL 200 may obtain KPIs associated with an operation process from a KPI repository 140 (202). An operation process may represent various activities in a particular domain such as projects, programs, products and other initiatives in the organization. The analytics for the operation process may be indicated by a plurality of KPIs associated with the operation process. The KPIs may be used to evaluate the success the operation process in which the organization engages. For example, with respect to the operation process of managing sales orders, the KPIs may include order complaints, time to process sales orders, number of sales orders, percentage use of external warehousing and distribution partners, billing accuracy. For another example, with respect to the operation process of optimizing transportation management, the KPIs may include inbound warehouse productivity, vehicle utilization, cumulative savings achieved, on-time delivery departure rate.

The KPI repository 140 may store KPIs associated with a variety of operation processes for an industry that the organization belongs to. The KPIs stored in the KPI repository 140 may be categorized into available KPIs and unavailable KPIs. The available KPIs may represent metrics that can be calculated based on data for the operation process stored in a data repository such as the data lake 150, while the unavailable KPIs may represent metrics that cannot be calculated based on data for the operation process stored in the data repository because, for example, some data used to calculate the KPIs is not available in the data repository. The available KPIs may include the available KPIs in use (or in-use KPIs) and the available KPIs not in use. The in-use KPIs may represent available KPIs that are outputted as data insights via a user interface such as a graphical user interface (GUI), while the available KPIs not in use may represent available KPIs that have not been considered as data insights. In an implementation, the DIGL 200 may retrieve a set of KPIs associated with the operation process from the data lake 150, identify unavailable KPIs from the set of KPIs, and remove the unavailable KPIs from the set of KPIs to obtain the available KPIs.

At the realization engine module 110, the DIGL 200 may identify available KPIs in use which is a subset of the available KPIs (204) and calculate a data enthalpy metric for the operation process based on a number of the available KPIs and a number of the available KPIs in use (206). The data enthalpy metric may indicate a relative amount of unutilized data for calculating KPIs.

In an implementation, the DIGL 200 may obtain a process significance metric for the operation process. The process significance metric may indicate a significance weight of an operation process in comparison with other operation processes. The process significance metric may be predetermined in the system or allocated by subject experts. The DIGL 200 may subtract the number of the in-use KPIs from the number of the available KPIs to obtain a number of available KPIs not in use. Then, the DIGL 200 may calculate the data enthalpy metric based on the process significance metric, the number of the available KPIs, and the number of available KPIs not in use. For example, the data enthalpy metric may be calculated by the Equation 1 below:

$$Data enthalpy metric = \frac{No . of available KPIs not in use * Process significance metric}{No . of available KPIs} \qquad Equation 1$$

In an example, with respect to the operation process of managing sales orders, the number of available KPIs not in use for is 5, the process significance metric assigned to the operation process is 100, and the number of available KPIs for the operation process is 12. The DIGL 200 may calculate the data enthalpy metric for the operation process with the Equation 1 to obtain the result

$$41.67 ( = \frac{5 * 100}{12} ) .$$

At the KPI design engine 122 of the design and distribution intelligence module 120, the DIGL 200 may obtain an insight recommendation model trained to predict a significance of an available KPI not in use. The insight recommendation model may be a pretrained machine learning model. In an implementation, the DIGL 200 may obtain test data from data dictionary for the data repository, KPI data in the KPI repository, and historical data insight reports for a plurality of operation processes as training dataset and train the insight recommendation model with the training dataset. The DIGL 200 may make use of any applicable artificial intelligence platform to train the insight recommendation model.

For example, the DIGL 200 may train the insight recommendation model with Google Vertex AI™. The Vertex AI uses a standard machine learning workflow: (1) gather training data; (2) formatting and labelling the training data; (3) set parameters for training the machine learning model and train the machine learning model; (4) evaluate the metrics of the trained machine learning model; and (5) deploy the trained machine learning model to make prediction.

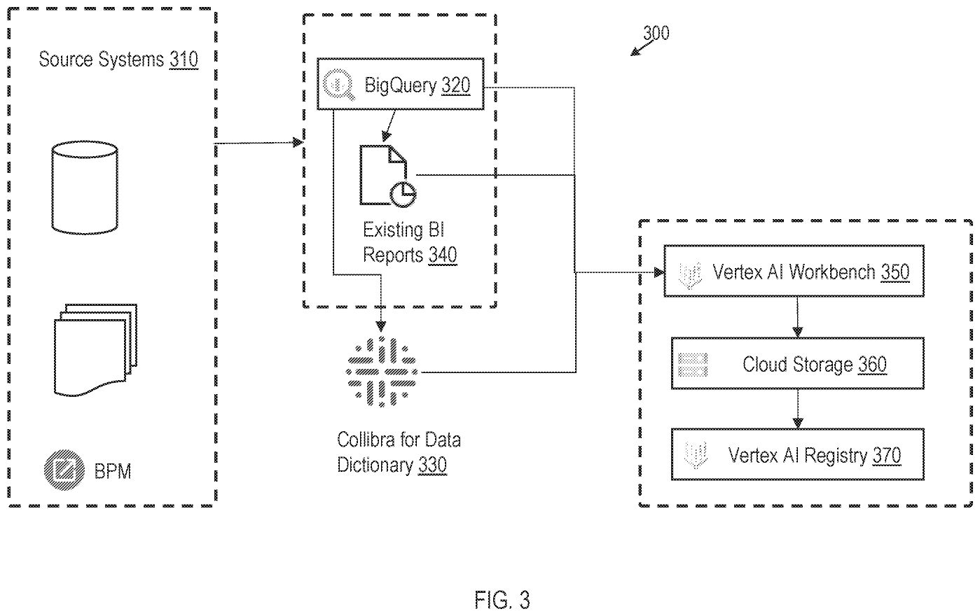

FIG. 3 shows an exemplary architecture 300 for training the insight recommendation model. The DIGL 200 may populate source data from various source systems 310 into a data lake such as Google BigQuery™ 320. The source data may include data relevant to various operation processes in the organization, which may be, for example, data in relational database management system (RDBMS), structured/semi-structured data, and business process details from the business process management (BPM) system. The DIGL 200 may make use of Collibra™ 330 to populate the data dictionary along with the BPM process details. The Collibra 330 may create an inventory of data assets in the BigQuery 320 and metadata about the data assets. Then, the DIGL 200 may provide the KPI data in BigQuery 320, the data dictionary in Collibra 330, and the business intelligence (BI) reports 340 to the Vertex AI workbench 350 for training the insight recommendation model. The DIGL 200 may store the trained insight recommendation model in the cloud storage buckets 360 and make use of the Vertex AI registry 370 to manage the lifecycle of the trained insight recommendation model.

Referring back to FIG. 1, at the distribution engine 124 of the design and distribution intelligence module 120, the DIGL 200 may execute the insight recommendation model to generate a KPI recommendation for the operation process based on the data enthalpy metric (208). In an implementation, the DIGL 200 may make use of the insight recommendation model to predict a KPI significance metric for each of the available KPIs not in use of a plurality of operation processes. The KPI significance metric may indicate a significance weight of a first KPI in comparison with other KPIs. For example, the insight recommendation model may identify ordinary data elements and critical data elements that are used to calculate a KPI and predict the KPI significance metric based on the number of the ordinary data elements and the number of critical data elements.

Then, for each of the available KPIs not in use, the DIGL 200 may calculate a KPI enthalpy metric based on the KPI significance metric of the KPI and a data enthalpy metric of an operation process associated with the KPI. In an example, to calculate a KPI enthalpy metric for a specific KPI, the DIGL 200 may identify available KPIs not in use associated with the same operation process as the specific KPI, add KPI significance metrics of the available KPIs not in use to obtain a subtotal KPI significance metric, and calculate the KPI enthalpy metric for the specific KPI based on the subtotal KPI significance metric, the KPI significance metric of the KPI, and the data enthalpy metric of the same operation process, as shown in the Equation 2 below.

$$KPI enthalpy metric = \frac{Specific KPI metric}{Subtotal KPIs metric} * Process data enthalpy metric \qquad Equation 2$$

Where the Specific KPI metric represents the KPI significance metric of the specific KPI, the Subtotal KPIs metric represents the a sum of KPI significance metrics of the available KPIs not in use for the operation process, and the Process data enthalpy metric represents the data enthalpy metric for the operation process.

For example, the billing accuracy is one of the available KPIs not in use for the operation process of managing sales orders. The predicted KPI significant metric for the KPI of billing process is 75. The sum of KPI significance metrics of all available KPIs not in use for the operation process of managing sales orders is 550. The data enthalpy metric for the operation process is 41.67. The DIGL 200 may calculate the KPI enthalpy metric for the KPI of billing accuracy with the Equation 2 to obtain the result

$$5.68 ( = \frac{75}{550} * 41.67 ) .$$

After obtaining the KPI enthalpy metrics for the available KPIs not in use of the plurality of operation processes, the DIGL 200 may determine recommended KPIs based on the KPI enthalpy metrics. For example, the DIGL 200 may determine the KPIs whose KPI enthalpy metrics exceed a predetermined metric threshold as the recommended KPIs. For another example, the DIGL 200 may select a number of KPIs with the highest KPI enthalpy metrics as the recommended KPIs.

At the distribution engine 124 of the design and distribution intelligence module 120, the DIGL 200 may output the recommended KPIs, for example, via the GUI (210). The outputted KPI recommendation may be validated, for example, by subject experts who may provide the validation result to the DIGL 200 via the GUI. When receiving a validation result for the KPI recommendation and the validation result indicates the KPI recommendation is approved, the DIGL 200 may use the recommended KPIs as data insights, for example, in customized reports or dashboards (212).

Where the validation result indicates the KPI recommendation is rejected, the DIGL 200 may trigger to train the insight recommendation model with new training dataset (214) and execute the trained insight recommendation model to generate another new KPI recommendation. In an example, the DIGL 200 may select the new training dataset based on new criteria set by the subject experts validating the KPI recommendation.

Moreover, at the data pooler 132 of the intelligent data auditing module 130, the DIGL 200 may monitor the updates in the data lake 150. When new data are stored into the data lake 150, the DIGL 200 may determine if there is any new available KPIs that can be calculated using the new data and the KPIs were unavailable before. Where there are such new available KPIs, the DIGL 200 may update the KPI recommendation based on the new available KPIs.

In an example, the DIGL 200 may subscribe data update events in the data lake 150. When receiving an event indicating that new data is stored into the data lake 150, the DIGL 200 may update the available KPIs based on the new data. For example, the DIGL 200 may determine one or more additional KPIs that can be calculated based on the new data and include the additional KPIs to the available KPIs. Then, the DIGL 200 may recalculate the data enthalpy metric based on the number of the updated available KPIs and execute the insight recommendation model to generate KPI recommendation for the operation process based on the recalculated data enthalpy metric.

At the data usage tracker 134 of the intelligent data auditing module 130, the DIGL 200 may track the usage of the data in the data lake 150 that are used to generate KPIs for various reports and dashboards. In an example, the DIGL 200 may generate knowledge graph for the reports and dashboards to track the usage of the data assets and the individual data elements within the data asset along with its lineage.

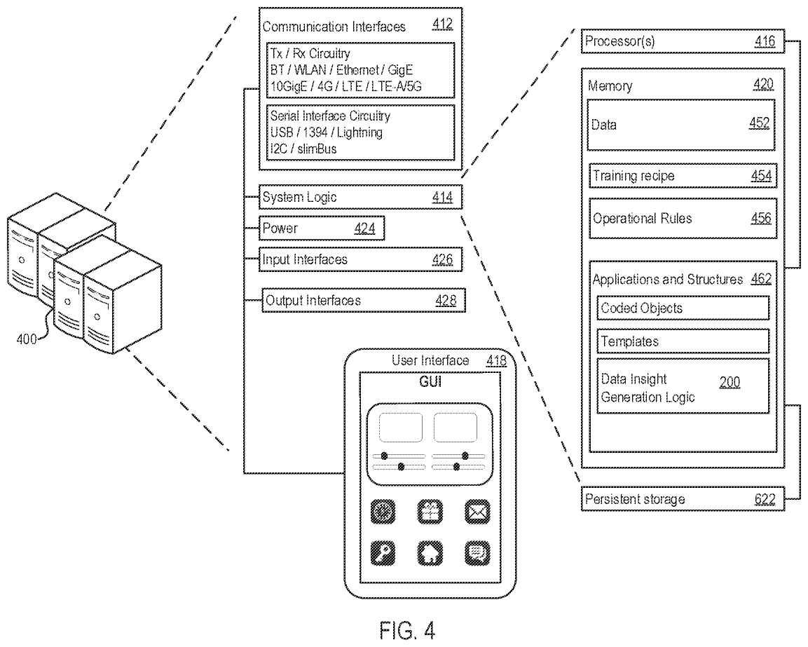

FIG. 4 shows an exemplary specific execution environment for executing the data insight generation logic 200 as described above. The execution environment 400 may include system logic 414 to support execution of the logics described above. The system logic 412 may include processors 416, memory 420, and/or other circuitries. The memory 420 may include global federated learning model 452, training recipe 454, and operational rules 456. The memory 520 may further include applications and structures 662, for example, coded objects, machine instructions, templates, or other structures to support calculating the data enthalpy metric for the operation process, executing the insight recommendation model, outputting the KPI recommendation, or other tasks described above. The applications and structures may implement the data insight generation logic 200.

The execution environment 400 may also include communication interfaces 412, which may support wireless, e.g. Bluetooth, Wi-Fi, WLAN, cellular (4G, LTE/A, 5G), and/or wired, Ethernet, Gigabit Ethernet, optical networking protocols. The communication interfaces 412 may also include serial interfaces, such as universal serial bus (USB), serial ATA, IEEE 1394, lighting port, I²C, slimBus, or other serial interfaces. The execution environment 400 may include power functions 424 and various input interfaces 426. The execution environment may also include a user interface 418 that may include human-to-machine interface devices and/or graphical user interfaces (GUI). In some implementations, the system logic 414 may be distributed over one or more physical machines or be implemented as one or more virtual machines.

The methods, devices, processing, circuitry, and logic described above may be implemented in many different ways and in many different combinations of hardware and software. For example, all or parts of the implementations may be circuitry that includes an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CD-ROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when executed by the circuitry.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

What is claimed is:

1. A method for increasing data enthalpy realization, the method comprising:
obtaining, with a processor circuitry, available Key Performance Indicators (KPIs) associated with an operation process from a KPI repository, the available KPIs representing metrics that can be calculated based on data for the operation process stored in a data repository;
identifying, with the processor circuitry, in-use KPIs comprising a subset of the available KPIs, the in-use KPIs being outputted as data insights via a user interface;
calculating, with the processor circuitry, a data enthalpy metric for the operation process based on a number of the available KPIs and a number of the in-use KPIs, the data enthalpy metric indicating a relative amount of unutilized data for calculating a KPI;
obtaining, with the processor circuitry, an insight recommendation model trained to predict a significance of an available KPI not in use;
executing, with the processor circuitry, the insight recommendation model to generate a KPI recommendation for the operation process based on the data enthalpy metric; and
outputting, with the processor circuitry, the KPI recommendation via the user interface.

2. The method of claim 1, where the obtaining the available KPIs associated with the operation process comprises:
retrieving a set of KPIs associated with the operation process from the KPI repository;
identifying unavailable KPIs from the set of KPIs, the unavailable KPIs representing KPIs that cannot be calculated due to required data for the calculation being absent from the data repository;
removing the unavailable KPIs from the set of KPIs to obtain the available KPIs.

3. The method of claim 2, where the calculating the data enthalpy metric comprises:
obtaining a process significance metric for the operation process, the process significance metric indicating a significance weight of an operation process in comparison with other operation processes;
subtracting the number of the in-use KPIs from the number of the available KPIs to obtain a number of available KPIs not in use; and
calculating the data enthalpy metric based on the process significance metric, the number of available KPIs, and the number of available KPIs not in use.

4. The method of claim 1, where the executing the insight recommendation model to generate the KPI recommendation for the operation process based on the data enthalpy metric comprises:
predicting, with the insight recommendation model, a KPI significance metric for each of the available KPIs not in use of a plurality of operation process, the KPI significance metric indicating a significance weight of a first KPI in comparison with other KPIs;
for each of the available KPIs not in use, calculating a KPI enthalpy metric based on the KPI significance metric of the first KPI and a data enthalpy metric of an operation process associated with the first KPI; and
determining recommended KPIs based on the KPI enthalpy metrics.

5. The method of claim 4, where the calculating the KPI enthalpy metric comprises:
identifying available KPIs not in use associated with a same operation process as the KPI;
adding KPI significance metrics of the available KPIs not in use to obtain a subtotal KPI significance metric;
calculating the KPI enthalpy metric for the KPI based on the subtotal KPI significance metric, the KPI significance metric of the KPI, and the data enthalpy metric of the same operation process.

6. The method of claim 4, where the determining the recommended KPIs based on the KPI enthalpy metrics comprises:
in response to a KPI enthalpy metric of a KPI exceeding a predetermined metric threshold, selecting the KPI as a recommended KPI.

7. The method of claim 1, where the method further comprises:
in response to new data being stored into a data repository,
updating the available KPIs based on the new data;
recalculating the data enthalpy metric based on a number of the updated available KPIs; and
executing the insight recommendation model to generate KPI recommendation for the operation process based on the recalculated data enthalpy metric.

8. The method of claim 7, where the updating the available KPIs comprises:
determining an additional KPI that can be calculated based on the new data; and
including the additional KPI to the available KPIs.

9. The method of claim 7, where the method further comprises:
monitoring the data repository to detect a new data in the data repository.

10. The method of claim 1, where the method further comprises:
obtaining test data from data dictionary for the data repository, KPI data in the KPI repository, and historical data insight reports for a plurality of operation processes as training dataset; and
training the insight recommendation model with the training dataset.

11. The method of claim 10, where the method further comprises:
receiving a validation result for the KPI recommendation via the user interface;
in response to the validation result indicating the KPI recommendation being rejected, triggering to train the insight recommendation model with new training dataset and execute the trained insight recommendation model to generate a new KPI recommendation.

12. A system for increasing data enthalpy realization, the system comprising:
a memory having stored thereon executable instructions;
a processor circuitry in communication with the memory, the processor circuitry when executing the instructions configured to:
obtain available Key Performance Indicators (KPIs) associated with an operation process from a KPI repository, the available KPIs representing metrics that can be calculated based on data for the operation process stored in a data repository;
identify in-use KPIs comprising a subset of the available KPIs, the in-use KPIs being outputted as data insights via a user interface;
calculate a data enthalpy metric for the operation process based on a number of the available KPIs and a number of the in-use KPIs, the data enthalpy metric indicating a relative amount of unutilized data for calculating a KPI;
obtain an insight recommendation model trained to predict a significance of an available KPI not in use;
execute the insight recommendation model to generate a KPI recommendation for the operation process based on the data enthalpy metric; and
output the KPI recommendation via the user interface.

13. The system of claim 12, where the processor circuitry is configured to:
retrieving a set of KPIs associated with the operation process from the KPI repository;
identifying unavailable KPIs from the set of KPIs, the unavailable KPIs representing KPIs that cannot be calculated due to required data for the calculation being absent from the data repository;
removing the unavailable KPIs from the set of KPIs to obtain the available KPIs.

14. The system of claim 13, where the processor circuitry is configured to:
obtaining a process significance metric for the operation process, the process significance metric indicating a significance weight of an operation process in comparison with other operation processes;
subtracting the number of the in-use KPIs from the number of the available KPIs to obtain a number of available KPIs not in use; and
calculating the data enthalpy metric based on the process significance metric, a total number of KPIs in the set of KPIs associated with the operation process, and the number of available KPIs not in use.

15. The system of claim 13, where the processor circuitry is configured to:
predicting, with the insight recommendation model, a KPI significance metric for each of the available KPIs not in use of a plurality of operation process, the KPI significance metric indicating a significance weight of a first KPI in comparison with other KPIs;
for each of the available KPIs not in use, calculating a KPI enthalpy metric based on the KPI significance metric of the first KPI and a data enthalpy metric of an operation process associated with the first KPI; and
determining recommended KPIs based on the KPI enthalpy metrics.

16. The system of claim 15, where the processor circuitry is configured to:
identifying available KPIs not in use associated with a same operation process as the KPI;
adding KPI significance metrics of the KPIs not in use to obtain a subtotal KPI significance metric;
calculating the KPI enthalpy metric for the KPI based on the subtotal KPI significance metric, the KPI significance metric of the KPI, and the data enthalpy metric of the same operation process.

17. The system of claim 12, where the processor circuitry is further configured to:
in response to new data being stored into a data repository,
updating the available KPIs based on the new data;
recalculating the data enthalpy metric based on a number of the updated available KPIs; and
executing the insight recommendation model to generate KPI recommendation for the operation process based on the recalculated data enthalpy metric.

18. The system of claim 17, where the processor circuitry is configured to:
determining an additional KPI that can be calculated based on the new data; and
including the additional KPI to the available KPIs.

19. The system of claim 12, where the processor circuitry is further configured to:
obtaining test data from data dictionary for the data repository, KPI data in the KPI repository, and historical data insight reports for a plurality of operation processes as training dataset; and
training the insight recommendation model with the training dataset.

20. A product for recommending data insights, the product comprising:
non-transitory machine-readable media; and
instructions stored on the machine-readable media, the instructions configured to, when executed, cause a processor circuitry to:
obtain available Key Performance Indicators (KPIs) associated with an operation process from a KPI repository, the available KPIs representing metrics that can be calculated based on data for the operation process stored in a data repository;
identify in-use KPIs comprising a subset of the available KPIs, the in-use KPIs being outputted as data insights via a user interface;
calculate a data enthalpy metric for the operation process based on a number of the available KPIs and a number of the in-use KPIs, the data enthalpy metric indicating a relative amount of unutilized data for calculating a KPI;
obtain an insight recommendation model trained to predict a significance of an available KPI not in use;
execute the insight recommendation model to generate a KPI recommendation for the operation process based on the data enthalpy metric; and
output the KPI recommendation via the user interface.
